(19) United States
(12) Patent Application Publication
(10) Pub. No.: US 2015/0345729 A1
(43) Pub. Date: Dec. 3, 2015

(54) ILLUMINATION APPARATUS FOR VEHICLE

(71) Applicants: Chien-Chung Liao, Hsin-Chu (TW); Fu-Ming Chuang, Hsin-Chu (TW)

(72) Inventors: Chien-Chung Liao, Hsin-Chu (TW); Fu-Ming Chuang, Hsin-Chu (TW)

(73) Assignee: CORETRONIC CORPORATION, Hsin-Chu (TW)

(21) Appl. No.: 14/631,874

(22) Filed: Feb. 26, 2015

(30) Foreign Application Priority Data
Jun. 3, 2014 (TW) 103119220

(51) Int. Cl. F21S 8/10

(52) U.S. Cl. CPC F21S 48/1721; F21S 48/125; F21S 48/1216; F21S 48/1225; F21Y 2101/02

(57) ABSTRACT

An illumination apparatus for vehicle including at least one light source, a light valve, an optical wavelength conversion layer, and a projection lens set is provided. The at least one light source provides a light beam. The light valve is disposed on the transmission path of the light beam. The light valve controls a light shape of at least a portion of the light beam. The optical wavelength conversion layer is disposed on the transmission path of the at least a portion of the light beam and includes a plurality of optical wavelength conversion units for converting the at least a portion of the light beam into an illumination light beam. The projection lens set is disposed on a transmission path of the illumination beam and configured to project the illumination beam. The optical wavelength conversion layer is located between the light valve and the projection lens set.

### CROSS-REFERENCE TO RELATED APPLICATION

This application claims the priority benefit of Taiwan application serial no. 103119220, filed on Jun. 3, 2014. The entirety of the above-mentioned patent application is hereby incorporated by reference herein and made a part of this specification.

### BACKGROUND OF THE INVENTION

1. Field of the Invention

The invention generally relates to an illumination apparatus, and more particularly, to an illumination apparatus for vehicle.

2. Description of Related Art

Recently, solid-state light sources, mainly being light-emitting diodes (LED) and laser diodes, have gradually taken a place in the headlight market. Luminous efficiency of the LED is between about 5%-8%, and the LED has different color temperatures to choose from and provides excellent power efficiency. On the other hand, since the laser diodes have a luminous efficiency of higher than about 20%, in order to break through light source restrictions of the LED, applicable high efficiency light sources produced by exciting phosphor powders using laser light source have gradually been developed. These two forms of light sources are the current main streams of solid-state illumination.

Moreover, a headlight light source module adopting a laser light source, in addition to using the laser light source to excite the phosphor powders for emitting light, also has an advantage in dynamically adjusting an amount of the light source for attaining illumination requirements of a variety of headlights with different brightness. Therefore, the architecture of the headlight light source module adopting the laser light source has a great potential in replacing the traditional high-pressure mercury lamp, and thereby becomes the light source of a new generation of mainstream headlight illumination.

Currently, an operating method of the headlight light source module, which adopts the laser light source, for vehicle is to emit a light beam by the laser light source, and after the light beam is incident to a beam combiner through an optical element, then excite the phosphor powders within the beam combiner to form a white light. Next, the white light is incident onto a reflective unit, and is then reflected by the reflective unit so as to be projected onto the front. However, as a result, the headlight light source module would has a larger volume and only one usable color temperature, and an alignment precision required by each element therein would be high. Moreover, such architecture also easily causes overheating of the beam combiner, and thereby results in heat dissipation difficulty, and further produces a problem of poor phosphor powder conversion efficiency.

Taiwan Patent No. M446346 discloses a laser light source projection system. China Patent Publication No. 102661563 discloses a laser light source headlight spectrum modulation system. China Patent Publication No. 101620318 discloses a projection system. China Patent Publication No. 1897072 discloses a laser light source display system. China Patent Publication No. 102127654 discloses an optical-fiber coupling semiconductor laser illuminating car lamp.

The information disclosed in this BACKGROUND section is only for enhancement of understanding of the BACKGROUND of the described technology and therefore it may contain information that does not form the prior art that is already known to a person of ordinary skill in the art. Further, the information disclosed in the BACKGROUND section does not mean that one or more problems to be resolved by one or more embodiments of the invention was acknowledged by a person of ordinary skill in the art.

### SUMMARY OF THE INVENTION

The invention provides an illumination apparatus for vehicle and may be used to adjust a light shape of a projected illumination light beam.

The invention provides an illumination apparatus for vehicle disposing an optical wavelength conversion layer on a substrate to facilitate the heat dissipation, and thus a problem of poor phosphor powder conversion efficiency due to difficulty in heat dissipation may be prevented.

Other features and advantages of the embodiments of the invention could be further understood by the technical features broadly embodied and described as follows. In order to attain one of the aforementioned objectives, parts or all of the aforementioned objectives, or other objectives, one embodiment of the invention provides an illumination apparatus for vehicle. The illumination apparatus for vehicle includes at least one light source, a light valve, an optical wavelength conversion layer, and a projection lens set. The at least one light source provides a light beam. The light valve is located on a transmission path of the light beam, wherein the light valve controls a light shape of at least a portion of the light beam. The optical wavelength conversion layer is located on the transmission path of the at least a portion of the light beam. The optical wavelength conversion layer includes a plurality of optical wavelength conversion units for converting the at least a portion of the light beam into an illumination light beam. The projection lens set is located on a transmission path of the illumination light beam for projecting out the illumination light beam, wherein the optical wavelength conversion layer is located between the light valve and the projection lens set.

In an embodiment of the invention, the light valve includes a digital micromirror device, the digital micromirror device includes a plurality of microlenses, each of the optical wavelength conversion units corresponds to some of the microlenses, and the some of the microlenses control the at least a portion of the light beam to incident on each of the corresponding optical wavelength conversion unit.

In an embodiment of the invention, the optical wavelength conversion units include a plurality of first optical wavelength conversion units and a plurality of second optical wavelength conversion units. The illumination light beam includes at least one first sub-illumination light beam and at least one second sub-illumination light beam. The first sub-illumination light beam and the second sub-illumination light beam are respectively converted by the first optical wavelength conversion units and the second optical wavelength conversion units, and a color temperature of the first sub-illumination light beam is different from a color temperature of the second sub-illumination light beam.

In an embodiment of the invention, the optical wavelength conversion layer further includes a plurality of shielding elements, and each of the shielding elements is disposed among the optical wavelength conversion units.

In an embodiment of the invention, the optical wavelength conversion layer further includes a substrate. The substrate has a first surface and a second surface opposite to the first surface, and the optical wavelength conversion units are disposed on the first surface.

In an embodiment of the invention, the optical wavelength conversion layer further includes an optical micro-structure layer disposed on the second surface and located between the optical wavelength conversion layer and the projection lens set.

In an embodiment of the invention, each of the microlenses is suitable to rotate independently and controls a reflection direction of the at least a portion of the light beam irradiated on each of the microlenses, so as to adjust the light shape of the at least a portion of the light beam incident on the optical wavelength conversion layer.

In an embodiment of the invention, the illumination apparatus for vehicle further includes a light condensing element, a light uniforming element, and a relay device. The light condensing element is located on the transmission path of the light beam. The light uniforming element is located on the transmission path of the light beam, wherein the light condensing element is located between the at least one light source and the light uniforming element. The relay device is located on the transmission path of the light beam and located between the light uniforming element and the digital micromirror device, and the light uniforming element is located between the light condensing element and the relay device.

In an embodiment of the invention, an amount of the at least one light source is plural, the light condensing element includes a plurality of condenser lenses, and each of the condenser lenses is corresponded to each of the light sources.

In an embodiment of the invention, an amount of the at least one light source is plural, the light condensing element includes a plurality of optical fibers, and each of the optical fibers is corresponded to each of the light sources.

In an embodiment of the invention, the illumination apparatus for vehicle further includes at least one total internal reflection prism located between the light valve and the optical wavelength conversion layer.

In an embodiment of the invention, the light beam is transmitted to the light valve through the light condensing element, the light uniforming element, and the relay device, sequentially.

In view of the foregoing, the embodiments of the invention may achieve one of the following advantages or effects. The illumination apparatus for vehicle in the embodiments of the invention may control a portion of the light beam to be projected into each of the corresponding optical wavelength conversion units through the light valve, and thereby may achieve a function of steplessly adjusting the light shape. The illumination apparatus for vehicle may also control an illumination area of the required light shape with a modulation of the light valve, so as to adapt to a variety of driving conditions.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic architecture diagram of an illumination apparatus for vehicle according to an embodiment of the invention.

FIG. 1B is a schematic diagram of a microlens of a digital micromirror device of FIG. 1A.

FIG. 1C is a schematic front view diagram of an optical wavelength conversion layer of FIG. 1A.

FIG. 2A, FIG. 3A, FIG. 4A, and FIG. 5A are respectively schematic diagrams of different illumination light beams projected by the illumination apparatus for vehicle of FIG. 1A.

FIG. 2B, FIG. 3B, FIG. 4B, and FIG. 5B are respectively schematic diagrams illustrating light shapes of the illumination light beams from FIG. 2A, FIG. 3A, FIG. 4A and FIG. 5A.

FIG. 6A is a schematic diagram illustrating another optical wavelength conversion layer of FIG. 1A.

FIG. 6B is a spectral power versus wavelength graph for the lights with different color temperatures in FIG. 6A.

FIG. 7 is a schematic diagram illustrating yet another optical wavelength conversion layer of FIG. 1A.

FIG. 8 is a schematic diagram illustrating still another optical wavelength conversion layer of FIG. 1A.

FIG. 9 is a schematic diagram of an illumination apparatus for vehicle according to another embodiment of the invention.

FIG. 10 is a schematic diagram of an illumination apparatus for vehicle according to yet another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

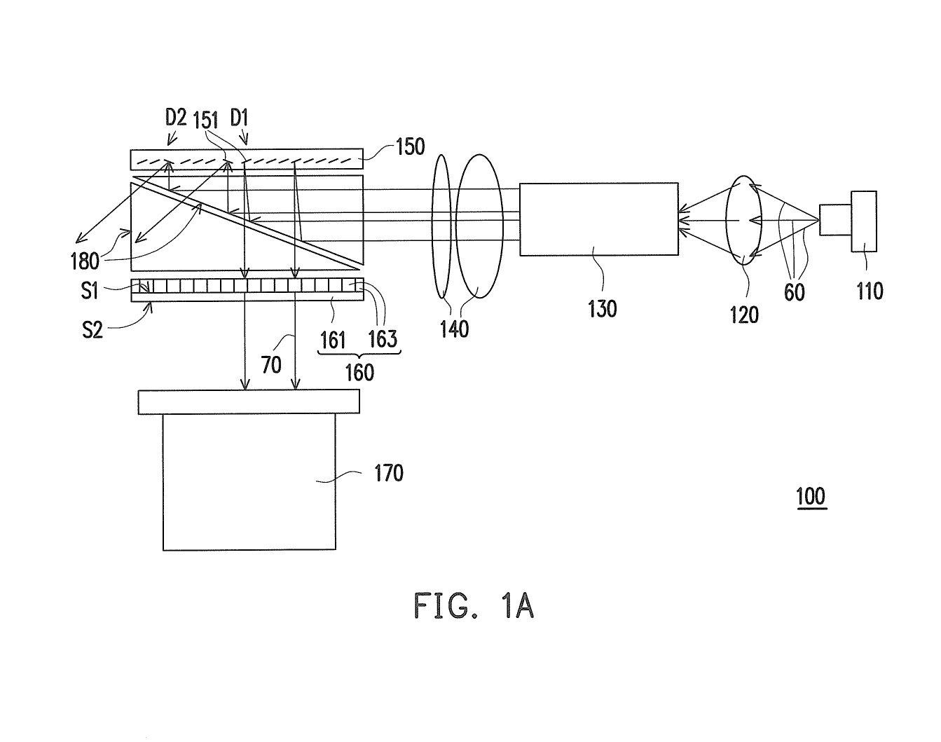

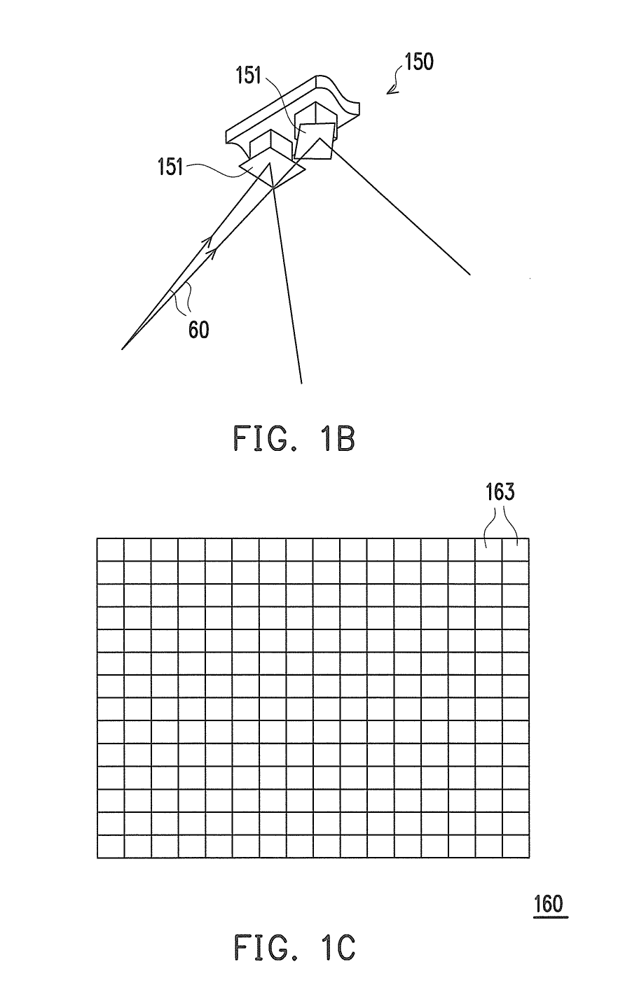

Referring to FIG. 1A, an illumination apparatus 100 for vehicle of the application includes at least one light source 110, a light condensing element 120, a light uniforming element 130, a relay device 140, a light valve 150, an optical wavelength conversion layer 160, and a projection lens set 170, and the light valve is defined as an optical element for controlling the direction of the light beam or whether the light beam passes through or not. It can be known by those in the field of optical technology that the light valve may be a reflective light valve, such as digital micromirror device (DMD) or liquid crystal on silicon (LCOS) and so forth, or a transmissive light valve, such as liquid crystal panel and so forth, but the invention is not limited thereto.

In the embodiment, the light source 110 is adapted to provide a light beam 60. For example, in the embodiment, the light source 110 may be blue laser diode(s), and thus the light beam 60 is a blue laser light beam, but the invention is not limited thereto. In other embodiments, the light source 110 may also be other type(s) of laser diode(s) or high luminance light-emitting diode(s), or other type(s) of high luminance light source 110. In addition, in the embodiment, the light condensing element 120 is, for example, a condenser lens; the light uniforming element 130 is, for example, an integrator rod or a lens array such as a fly-eye lens array (not shown); and the relay device 140 is, for example a relay lens set. However, the invention is not limited thereto.

Specifically, as shown in FIG. 1A, the light condensing element 120, the light uniforming element 130, the relay device 140, and the light valve 150 (the light valve 150 in the embodiment is, for example, the digital micromirror device) are all located on a transmission path of the light beam 60. The light condensing element 120 is located between the light source 110 and the light uniforming element 130, and the light uniforming element 130 is located between the light condensing element 120 and the relay device 140. The relay device 140 is located between the light uniforming element 130 and the digital micromirror device 150, and the light uniforming element 130 is located between the light condensing element 120 and the relay device 140.

As shown in FIG. 1A, when the light source 110 emits the light beam 60, the light beam 60 may firstly be condensed by the light condensing element 120 and then transmitted into the light uniforming element 130, and then outputted by the light uniforming element 130. Next, the light beam 60 is transmitted to the digital micromirror device 150 by the relay device 140. In other words, in the embodiment, the light beam 60 may sequentially be transmitted through the light condensing element 120, the light uniforming element 130, and the relay device 140 to the digital micromirror device 150.

Referring to FIG. 1A and FIG. 1B, in the embodiment, the digital micromirror device 150 includes a plurality of microlenses 151 (as shown in FIG. 1B), and the digital micromirror device 150 controls a light shape of at least a portion of the light beam 60 through the microlenses 151. For example, in the embodiment, the microlenses 151 may be controlled to oscillate in small amplitude/range by means/method of pulse width modulation (PWM), so as to further control an intensity ratio of the light projected onto different directions.

Furthermore, as shown in FIG. 1B, in the embodiment, the microlens 151 may be an element having an On-state and an Off-state, and may rotate independently to control a reflection direction of the at least a portion of the light beam 60 projected onto each of the microlenses 151. For example, as shown in FIG. 1A and FIG. 1B, when the microlens 151 faces towards a specific direction D1, it is in the On-state. At this time, if the light beam 60 is transmitted onto the microlens 151, then it may be reflected and transmitted onto the optical wavelength conversion layer 160. On the other hand, when the microlens 151 faces towards another direction D2, it is in the Off-state. At this time, if the light beam 60 is transmitted onto the microlens 151, then it may be emitted along other direction and be guided towards the outside, and thus may not be transmitted onto the optical wavelength conversion layer 160. As such, the light shape of the light beam 60 incident onto the optical wavelength conversion layer 160 may be different due to the On-state or the Off-state of the microlens 151. In other words, in the embodiment, the light shape of the light beam 60 incident onto the optical wavelength conversion layer 160 may be adjusted through independently controlling the On-state or the Off-state of each of the microlenses 151.

Moreover, referring to FIG. 1A again, in the embodiment, the illumination apparatus 100 for vehicle may selectively be disposed with at least one total internal reflection (TIR) prism 180, wherein the TIR prism 180 is located between the relay device 140 and the digital micromirror device 150. The light beam 60, after passing through the relay device 140, may be reflected by the TIR prism 180 so as to be transmitted to the digital micromirror device 150, and may thus adjust an advancing/transmitting direction of the light beam 60 in order to facilitate in the adjustment of the light shape by the digital micromirror device 150. However, the invention is not limited thereto. The embodiment as illustrated in FIG. 1A is to use the TIR prism 180 to change and adjust the advancing/transmitting direction of the light beam 60; however, under the condition that the digital micromirror device 150 is in well control to be able to provide a required light shape, the location of the digital micromirror device 150 may be adjusted to directly reflect the light beam 60 in order to obtain the required light shape without additional disposition of the TIR prism 180.

Referring to FIG. 1A and FIG. 1C, the optical wavelength conversion layer 160 is located on the transmission path of the at least a portion of the light beam 60, and the optical wavelength conversion layer 160 includes a substrate 161 and a plurality of optical wavelength conversion units 163. For example, in the embodiment, a material of the substrate 161 may be glass or other suitable transparent material. On the other hand, each of the optical wavelength conversion units 163 is grid-shaped, and a material thereof is, for example, yellow phosphor powder or yellow quantum dot material capable to be used to convert the blue light beam 60 into white light. More specifically, in the embodiment, the substrate 161 has a first surface S1 and a second surface S2 opposite to the first surface S1, and the optical wavelength conversion units 163 are, for example, disposed on the first surface 51 by means of array. In other words, in the embodiment, the optical wavelength conversion layer 160 is a phosphor powder layer having a plurality of grid-shaped optical wavelength conversion units 163, but the invention is not limited thereto. In addition, as compared to the conventional technology using the phosphor powders disposed within a beam combiner, the embodiments of the invention may dissipate the heat more easily through disposing the optical wavelength conversion layer 160 on the substrate 161, and thereby may prevent the problem of poor phosphor powder conversion efficiency due to difficulty in heat dissipation.

Furthermore, in the embodiment, each of the optical wavelength conversion units 163 is corresponded to some of the microlenses 151 (a part of the microlenses 151), and the light beam 60 after the modulation through each of the microlenses 151 of the digital micromirror device 150 would be transmitted onto each of the corresponding optical wavelength conversion units 163. For example, in one embodiment, an amount of the optical wavelength conversion units 163 is not equal to an amount of the microlenses 151 and one optical wavelength conversion unit 163 may be corresponding to a plurality of microlenses 151, and the light beam 60 reflected by the corresponding microlenses 151 is to be incident onto each of the corresponding optical wavelength conversion units 163 so as to facilitate in the adjustment of the light shape. In other words, in the embodiment, the optical wavelength conversion units 163 and the microlenses 151 have a corresponding relationship of one-to-plurality (one-to-many), but the invention is not limited thereto. In another embodiment, the optical wavelength conversion units 163 and the microlenses 151 may also have a corresponding relationship of one-to-one.

Next, referring to FIG. 1A again, in the embodiment, the projection lens set 170 is located on a transmission path of an illumination light beam 70, and thus after the optical wavelength conversion layer 160 converts the at least a portion of the light beam 60 into the illumination light beam 70, the illumination light beam 70 may further be transmitted to the projection lens set 170 and be projected out of the illumination apparatus 100 for vehicle. Accordingly, since the illumination apparatus 100 for vehicle may control a portion of the light beam 60 to be incident onto each of the corresponding optical wavelength conversion units 163 through using some of the microlenses 151, the light shape of the light beam 60 incident onto the optical wavelength conversion layer 160 and a light shape of the illumination light beam 70 converted from the light beam 60 may both be adjusted. For instance, in the embodiment, the illumination apparatus 100 for vehicle may obtain the light shapes required by a high beam, a low beam, an adaptive front lighting system (AFS) through the modulation of the digital micromirror device 150 and so forth in response to a variety of driving conditions.

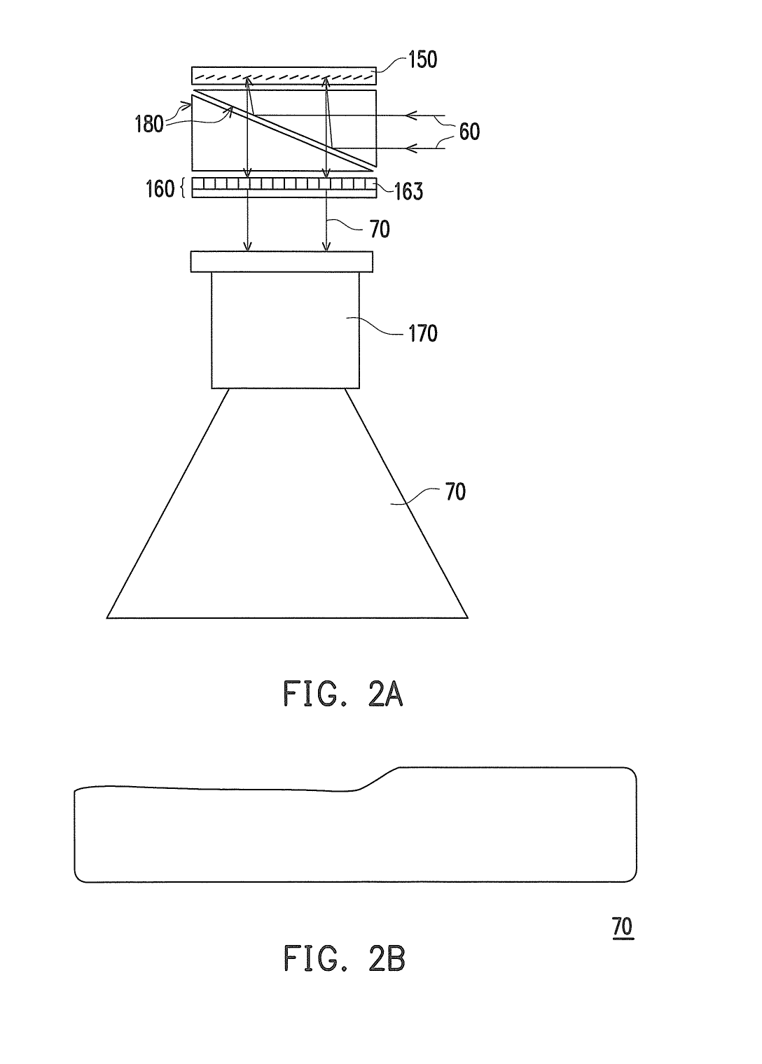

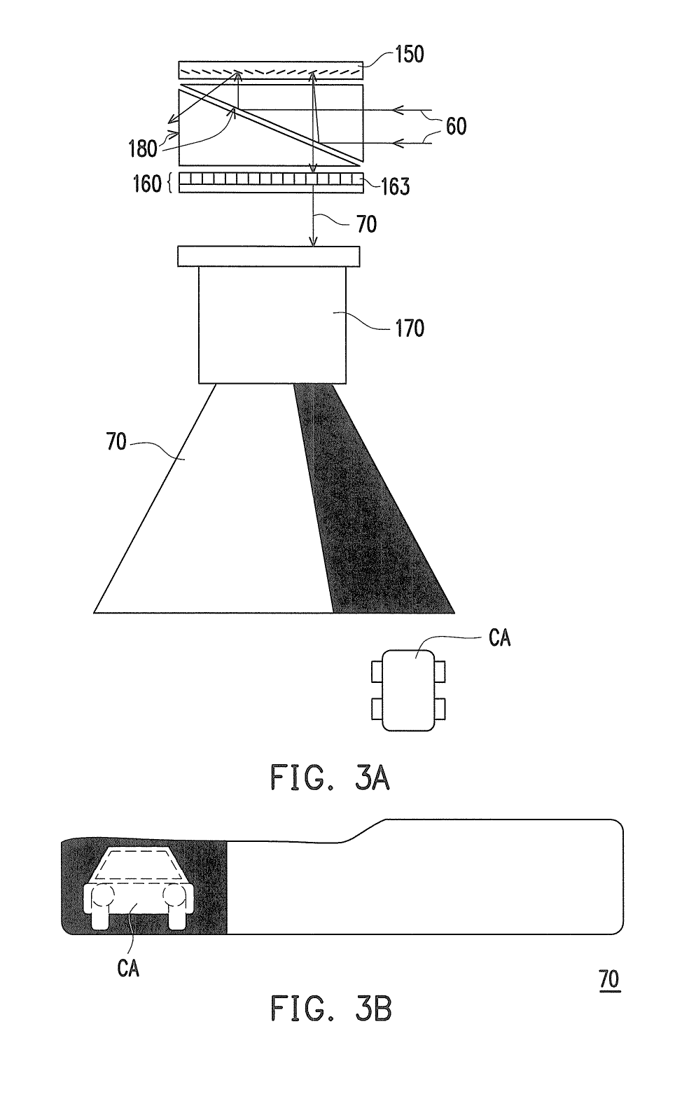

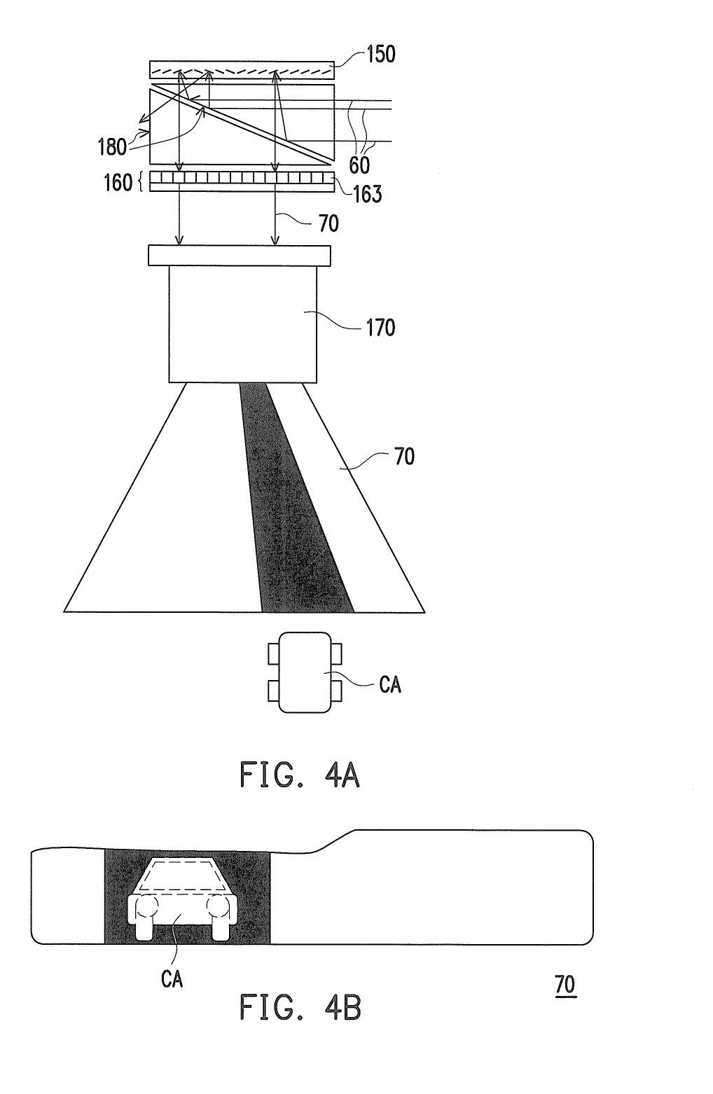

The following below, accompanied by FIG. 2A through FIG. 5B, provides further descriptions on how the illumination apparatus 100 for vehicle is to provide the required light shapes in response to a variety of driving conditions.

Referring to FIG. 2A and FIG. 2B, under a normal condition, each of the microlenses 151 of the digital micromirror device 150 is in the On-state, and then the light beam 60 transmitted to the digital micromirror device 150 may entirely be transmitted onto each of the optical wavelength conversion units 163 of the optical wavelength conversion layer 160 and be converted into the illumination light beam 70. Next, by using the projection lens set 170 to project the illumination light beam 70 onto the road ahead, an illumination effect with greater brightness may be obtained.

On the other hand, referring to FIG. 3A and FIG. 3B, when there is an incoming vehicle CA from an opposite direction at one side, the digital micromirror device 150 may control the microlenses 151 reflecting the light to the locations without vehicle into the On-state, and may control the microlenses 151 reflecting the light to the location of the incoming vehicle CA into the Off-state. At that time, only a portion of the light beam 60 transmitted to the digital micromirror device 150 would be transmitted onto each of the optical wavelength conversion units 163 of the optical wavelength conversion layer 160, and thus the light shape of the illumination light beam 70 projected by the projection lens set 170 would be condensed at the side without vehicle. Hence, under the condition of maintaining an adequate illumination, a person in the incoming vehicle CA from the opposite direction sensing glare may be prevented.

Furthermore, referring to FIG. 4A, FIG. 4B, FIG. 5A, and FIG. 5B, when the incoming vehicle CA from the opposite direction at the side is closer to our car, the digital micromirror device 150 may control the On-state or the Off-state of each of the microlenses 151 based on a relative angle between the incoming vehicle CA and our car. For example, in the embodiment, the digital micromirror device 150 may control the microlenses 151 reflecting the light to the locations without into the On-state, and may control the microlenses 151 reflecting the light to the location with the incoming vehicle CA into the Off-state (as shown in FIG. 4A). At the same time, under the condition that the incoming vehicle CA is getting closer and closer to our car, an adjustment of a region A of the microlenses 151 in the Off-state may be performed (as shown in FIG. 5A). Accordingly, a majority portion of the light may be controlled and transmitted onto each of the optical wavelength conversion units 163 corresponding to the optical wavelength conversion layer 160, while a minority portion of the light may be guided towards the outside. Therefore, the light shape of the illumination light beam 70 projected by the projection lens set 170 would be condensed at angles without vehicle and may accordingly be adjusted based on the relative angle between the incoming vehicle CA and our car, so that under the condition of maintaining an adequate illumination, a person in the incoming vehicle CA from the opposite direction sensing glare may be prevented.

In addition, as shown in FIG. 2B, FIG. 3B, FIG. 4B, and FIG. 5B, different light shapes of the variety of illumination light beams 70 projected by the aforementioned illumination apparatus 100 for vehicle are substantially distributed at regions under a horizontal cut-off line. This light shape distribution may enable the vehicle illumination applied in the illumination apparatus of the embodiment to meet or comply/conform with standards of relevant regulations.

As a result, since the illumination apparatus 100 for vehicle may control a portion of the light beam 60 to be incident onto each of the corresponding optical wavelength conversion units 163 through using some of the microlenses 151, it may achieve a function of stepless adjustment of the light shape under the condition of having only one light source 110, and may control the illumination area of the required light shape with the modulation of the digital micromirror device 150, so as to adapt to a variety of driving conditions.

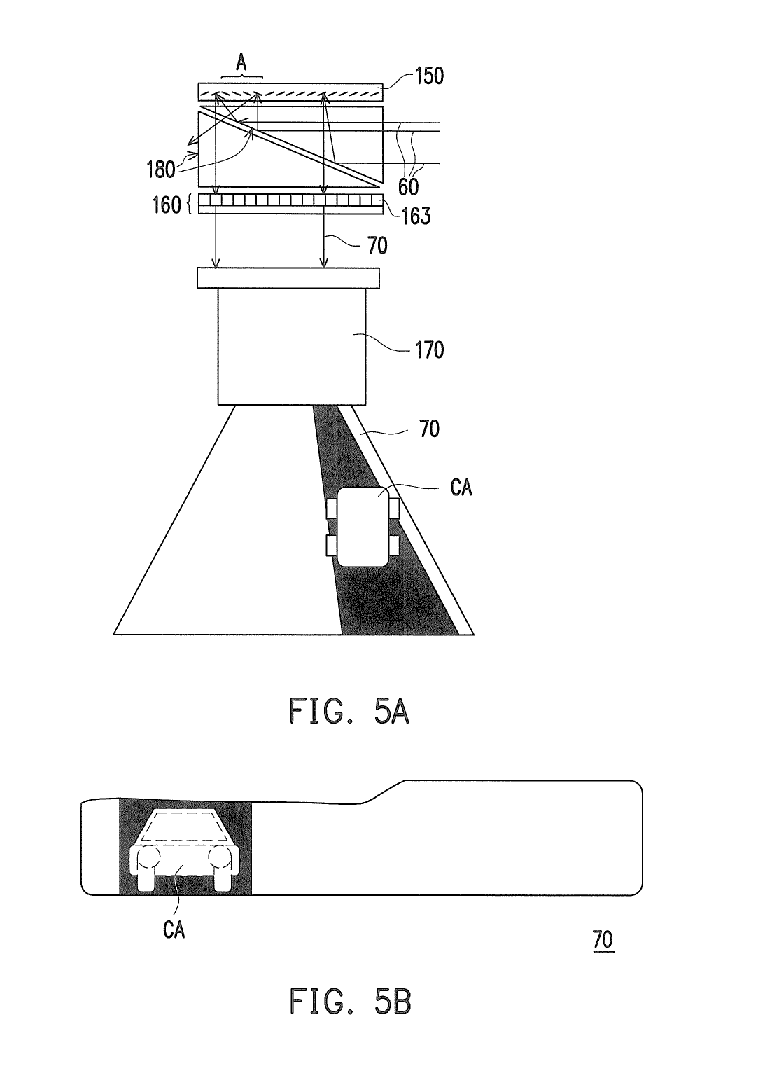

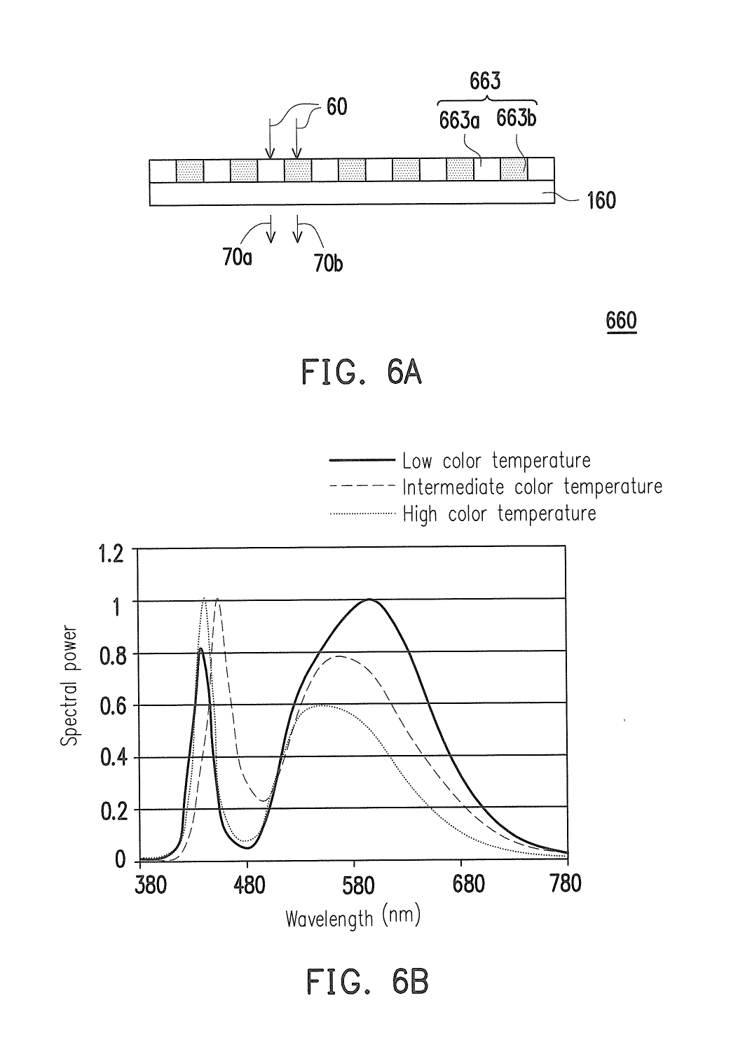

The following below, accompanied by FIG. 6A through FIG. 8, provides further descriptions targeting a variety of possible variations of the optical wavelength conversion layer 160.

Referring to FIG. 6A and FIG. 6B, the horizontal axis thereof indicates wavelength in units of nm, and the vertical axis thereof indicates normalized spectral power. In the embodiment, an optical wavelength conversion layer 660 of FIG. 6A is similar to the optical wavelength conversion layer 160 of FIG. 1C, whereas differences therebetween are described as follows. As shown in FIG. 6A, in the embodiment, optical wavelength conversion units 663 of the optical wavelength conversion layer 660 include a plurality of first optical wavelength conversion units 663a and a plurality of second optical wavelength conversion units 663b, wherein the first optical wavelength conversion units 663a and the second optical wavelength conversion units 663b may be multiple types of phosphor powder, such as a mixture of yellow phosphor powder and red phosphor powder, and mixing ratios between the yellow phosphor powder and the red phosphor powder in the first optical wavelength conversion units 663a and the second optical wavelength conversion units 663b are different. Hence, a color temperature of the illumination light beam 70 may be adjusted by controlling the mixing ratios of the various types of phosphor powder in the first optical wavelength conversion units 663a and the second optical wavelength conversion units 663b and the intensity of blue light beam 60.

For instance, as shown in FIG. 6B, the optical wavelength conversion units 663 may convert the blue light beam 60 into an illumination light beam 70 with lower color temperature when a ratio of the red phosphor powder contained therein is higher. While, the optical wavelength conversion units 663 may convert the blue light beam 60 into an illumination light beam 70 with intermediate color temperature when a ratio of the yellow phosphor powder contained therein is higher. In addition, when the intensity of the blue light beam 60 is stronger, the resulting illumination light beam 70 after the conversion may have higher color temperature.

Furthermore, referring to FIG. 6A again, since the mixing ratios of the phosphor powders fir the first optical wavelength conversion units 663a and the second optical wavelength conversion units 663b are different, the color temperatures for the illumination light beam 70 converted by the different optical wavelength conversion units 663 are also different. In other words, in the embodiment, the illumination light beam 70 may include at least one first sub-illumination light beam 70a and at least one second sub-illumination light beam 70b. The first sub-illumination light beam 70a and the second sub-illumination light beam 70b are respectively converted by the first optical wavelength conversion units 663a and the second optical wavelength conversion units 663b, and thus a color temperature of the first sub-illumination light beam 70a is different from a color temperature of the second sub-illumination light beam 70b.

Hence, under the condition of controlling the On- or Off-state of each of the microlenses 151, accompanied with the configuration of regions of the first optical wavelength conversion units 663a and the second optical wavelength conversion units 663b corresponding to each other, the illumination apparatus 100 for vehicle using the optical wavelength conversion layer 660 may adjust the color temperature of the first sub-illumination light beam 70 and the ratio of the second sub-illumination light beam 70b according to the actual needs, and thereby may obtain the color temperature required by the illumination light beam 70 projected by the illumination apparatus 100 for vehicle in response to the weather or user's preference needs.

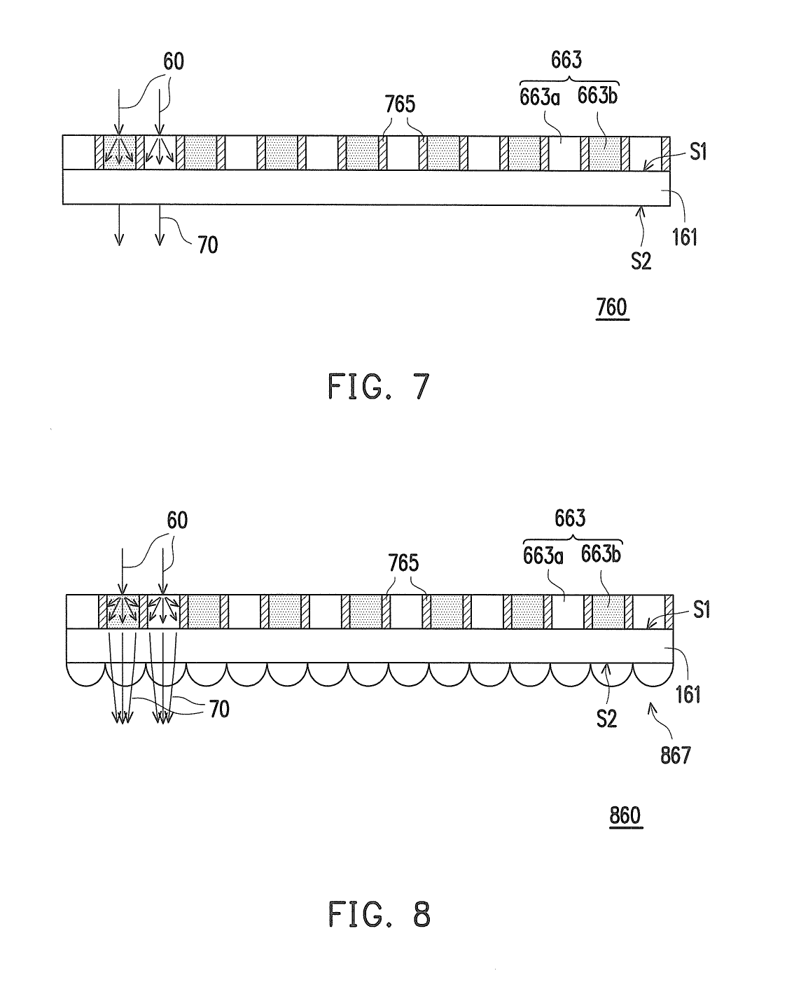

Referring to FIG. 7, in the embodiment, an optical wavelength conversion layer 760 of FIG. 7 is similar to the optical wavelength conversion layer 660 of FIG. 6A, and differences therebetween are described as follows. As shown in FIG. 7, in the embodiment, the optical wavelength conversion layer 760 further includes a plurality of shielding elements 765, and each of the shielding elements 765 is disposed among the optical wavelength conversion units 663. Specifically, since when the optical wavelength conversion units 663 covert the light beam 60 into the illumination light beam 70, the illumination light beams 70 leaves the optical wavelength conversion units 663 by means of scattering; therefore, in the embodiment, with the configuration of the shielding elements 765, the illumination light beam 70 from each of the optical wavelength conversion units 663 may be prevented from influencing each other due to scattering effect, and thereby is conducive in the optical design for the illumination area.

Referring to FIG. 8, an optical wavelength conversion layer 860 of FIG. 8 is similar to the optical wavelength conversion layer 760 of FIG. 7, and differences therebetween are described as follows. As shown in FIG. 8, in the embodiment, the optical wavelength conversion layer 860 may also selectively include an optical micro-structure layer 867 disposed on the second surface S2 of the substrate 161. In other words, when the optical wavelength conversion layer 860 is applied to the illumination apparatus 100 for vehicle of FIG. 1A, the optical micro-structure layer 867 is located between the optical wavelength conversion layer 860 and the projection lens set 170. More specifically, in the embodiment, the optical micro-structure layer 867 is, for example, a micro-lens layer, but the invention is not limited thereto. In other embodiments, the optical micro-structure layer 867 may also be a triangular prism layer or other optical micro-structure layer having a condensing effect. Specifically, in the embodiment, the illumination light beams 70, after leaving the optical wavelength conversion units 663, may be condensed by the optical micro-structure layer 867, and thereby increase an optical efficiency.

As a result, since the illumination apparatus 100 for vehicle applied with the structure of the optical wavelength conversion layer 660, 760 or 860 may also control a portion of the light beam 60 to be incident onto the each of the corresponding optical wavelength conversion units 663 through using some of the microlenses 151, it may achieve the function of steplessly adjusting the light shape under the condition of having only one light source 110, and may control the illumination area of the required light shape with the modulation of the digital micromirror device 150, so as to adapt to a variety of driving conditions. Hence, the illumination apparatus 100 for vehicle applied with the structure of the optical wavelength conversion layer 660, 760 or 860 also has the advantages as described in the previous embodiments, and no further elaboration will be provided.

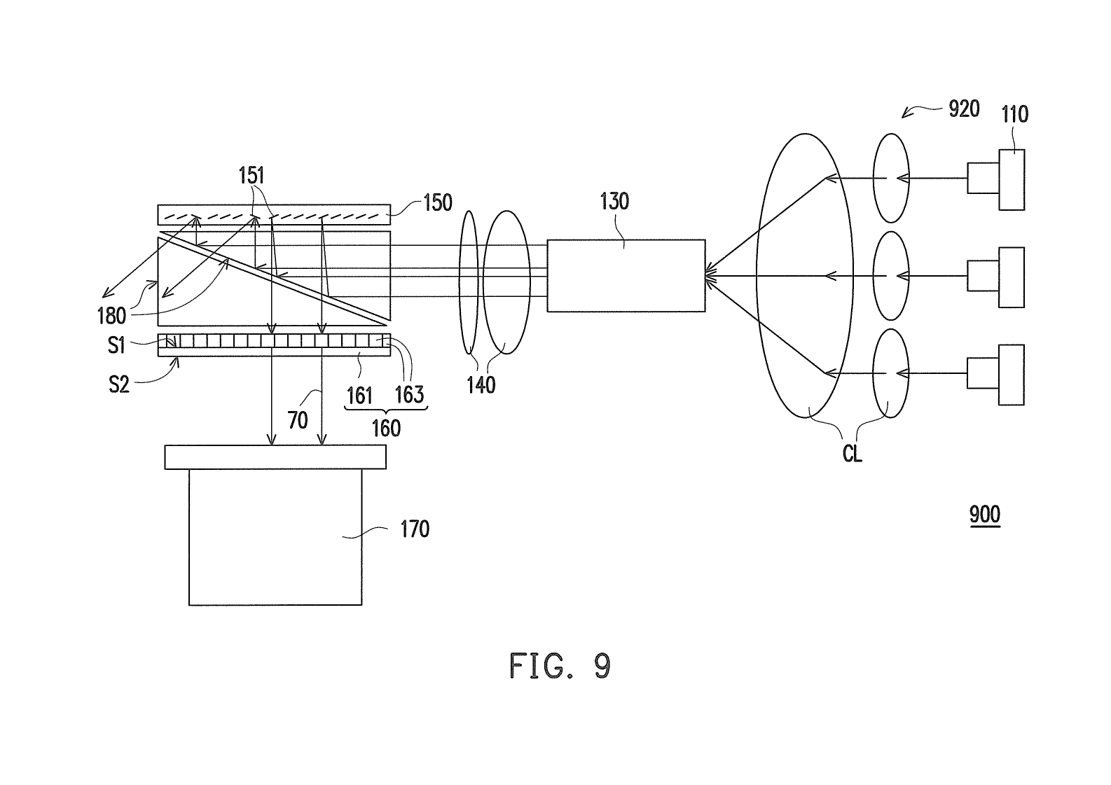

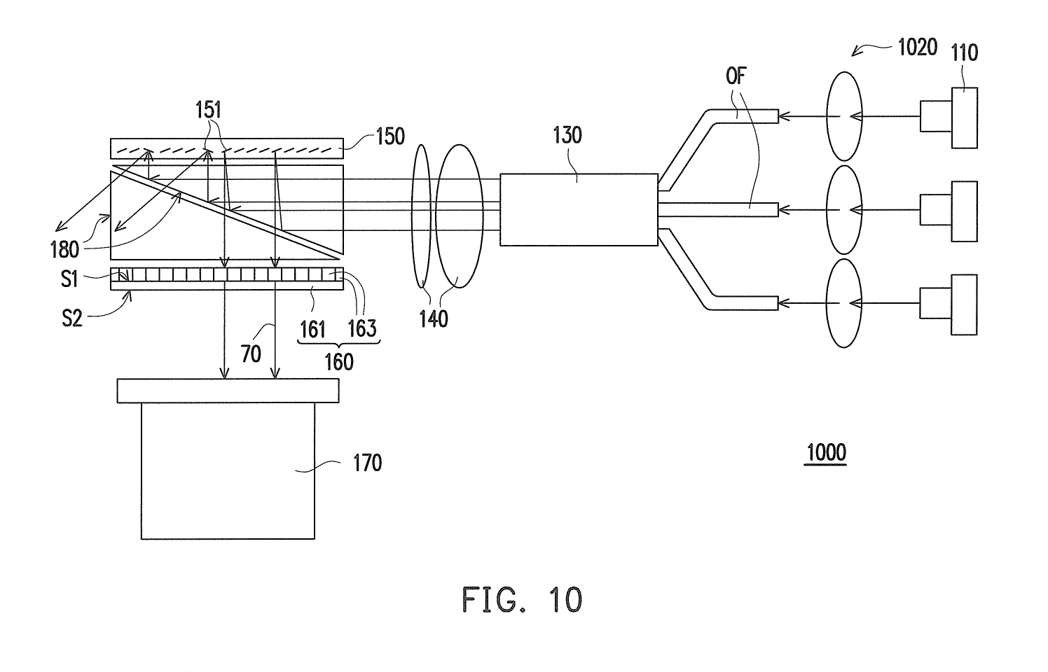

Referring to FIG. 9, in the embodiment, an illumination apparatus for vehicle 900 of FIG. 9 is similar to the illumination apparatus 100 for vehicle of FIG. 1A, and differences therebetween are described as follows. In the embodiment, an amount of the at least one light source 110 is plural. Moreover, a light condensing element 920 includes a plurality of condenser lenses CL, and each of the condenser lenses CL is corresponded to each of the light sources 110. In the embodiment, since a plurality of light sources 110 and a plurality of condenser lenses CL adopted as the light condensing element 920, the illumination apparatus for vehicle 900 may have higher brightness. In addition, since the illumination apparatus for vehicle 900 may also control a portion of the light beam 60 to be incident onto each of the corresponding optical wavelength conversion units 163 through using some of the microlenses 151, it may also achieve the function of steplessly adjusting the light shape, and may control the illumination area of the required light shape with the modulation of the digital micromirror device 150, so as to adapt to a variety of driving conditions. Hence, the illumination apparatus for vehicle 900 also has the advantages as mentioned in the illumination apparatus 100 for vehicle, and no further elaboration will be provided.

Referring to FIG. 10, in the embodiment, an illumination apparatus 1000 for vehicle of FIG. 10 is similar to the illumination apparatus 100 for vehicle of FIG. 1A, and differences therebetween are described as follows. In the embodiment, an amount of the at least one light source 110 is plural, a light condensing element 1020 includes a plurality of optical fibers OF, and each of the optical fibers OF is corresponded to each of the light sources 110. In the embodiment, since the optical fibers OF have tenuous structure and flexible nature, the optical fibers OF may easily be coupled into the light uniforming element 130. Thereby, it is conducive in disposing more light sources 110 and performing the configuration design for each of the optical elements in the illumination apparatus 1000 for vehicle. In addition, since the illumination apparatus 1000 for vehicle may also control a portion of the light beam 60 to be incident onto each of the corresponding optical wavelength conversion units 163 through using some of the microlenses 151, it may also achieve the function of steplessly adjusting the light shape, and may control the illumination area of the required light shape with the modulation of the digital micromirror device 150, so as to adapt to a variety of driving conditions. Hence, the illumination apparatus 1000 for vehicle also has the advantages as mentioned in the illumination apparatus 100 for vehicle, and no further elaboration will be provided.

In summary, the illumination apparatus for vehicles as disclosed in the embodiments of the invention may control a portion of the light beam to be incident onto each of the corresponding optical wavelength conversion units through using some of the microlenses, and thus may achieve the function of stepless adjustment of the light shape, and may control the illumination area of the required light shape with the modulation of the digital micromirror device, so as to adapt to a variety of driving conditions. Moreover, under the condition of controlling the On- or Off-state of each of the microlenses, and accompanied with the corresponding materials of the optical wavelength conversion units, the color temperature of the illumination light beam projected by the illumination apparatus for vehicle may be adjusted in response to the weather or the user's preference needs. In addition, as compared to the conventional technology using disposing the phosphor powders within a beam combiner, the embodiments of the invention may dissipate the heat more easily through disposing the optical wavelength conversion layer on the substrate, and thereby may prevent the problem of poor phosphor powder conversion efficiency due to difficulty in heat dissipation.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. An illumination apparatus for vehicle, comprising:
at least one light source, for providing a light beam;
a light valve, located on a transmission path of the light beam, wherein the light valve controls a light shape of at least a portion of the light beam;
an optical wavelength conversion layer, located on the transmission path of the at least a portion of the light beam, wherein the optical wavelength conversion layer comprises a plurality of optical wavelength conversion units for converting the at least a portion of the light beam into an illumination light beam; and
a projection lens set, located on a transmission path of the illumination light beam, for projecting the illumination light beam, wherein the optical wavelength conversion layer is located between the light valve and the projection lens set.

2. The illumination apparatus for vehicle as recited in claim 1, wherein the light valve comprises a digital micromirror device, the digital micromirror device comprises a plurality of microlenses, each of the optical wavelength conversion units corresponds to some of the microlenses, and the some of the microlenses control the at least a portion of the light beam to incident on each of the corresponding optical wavelength conversion unit.

3. The illumination apparatus for vehicle as recited in claim 1, wherein the optical wavelength conversion units comprise a plurality of first optical wavelength conversion units and a plurality of second optical wavelength conversion units, the illumination light beam comprises at least one first sub-illumination light beam and at least one second sub-illumination light beam, the first sub-illumination light beam and the second sub-illumination light beam are respectively converted by the first optical wavelength conversion units and the second optical wavelength conversion units, and a color temperature of the first sub-illumination light beam is different from a color temperature of the second sub-illumination light beam.

4. The illumination apparatus for vehicle as recited in claim 1, wherein the optical wavelength conversion layer further comprises a plurality of shielding elements, and each of the shielding elements is disposed among the optical wavelength conversion units.

5. The illumination apparatus for vehicle as recited in claim 1, wherein the optical wavelength conversion layer further comprises a substrate, the substrate has a first surface and a second surface opposite to the first surface, and the optical wavelength conversion units are disposed on the first surface.

6. The illumination apparatus for vehicle as recited in claim 5, wherein the optical wavelength conversion layer further comprises an optical micro-structure layer disposed on the second surface and located between the optical wavelength conversion layer and the projection lens set.

7. The illumination apparatus for vehicle as recited in claim 2, wherein each of the microlenses is suitable to rotate independently and controls a reflection direction of the at least a portion of the light beam rradiated on each of the microlenses, so as to adjust the light shape of the at least a portion of the light beam incident on the optical wavelength conversion layer.

8. The illumination apparatus for vehicle as recited in claim 1 further comprising:
a light condensing element, located on the transmission path of the light beam;
a light uniforming element, located on the transmission path of the light beam, wherein the light condensing element is located between the at least one light source and the light uniforming element; and
a relay device, located on the transmission path of the light beam, and located between the light uniforming element and the light valve, wherein the light uniforming element is located between the light condensing element and the relay device.

9. The illumination apparatus for vehicle as recited in claim 8, wherein an amount of the at least one light source is plural, the light condensing element comprises a plurality of condenser lenses, and each of the condenser lenses is corresponded to each of the light sources.

10. The illumination apparatus for vehicle as recited in claim 8, wherein an amount of the at least one light source is plural, the light condensing element comprises a plurality of optical fibers, and each of the optical fibers is corresponded to each of the light sources.

11. The illumination apparatus for vehicle as recited in claim 8 further comprising at least one total internal reflection prism located between the light valve and the optical wavelength conversion layer.

12. The illumination apparatus for vehicle as recited in claim 8, wherein the light beam is transmitted to the light valve through the light condensing element, the light uniforming element, and the relay device sequentially.
